(19) United States
(12) Patent Application Publication
(10) Pub. No.: US 2012/0040130 A1
(43) Pub. Date: Feb. 16, 2012

(54) Minireactor Array

(76) Inventors: James Micheal Harris, Elmira, NY (US); James Scott Sutherland, Corning, NY (US); Andrew David Woodfin, Painted Post, NY (US)

(21) Appl. No.: 13/266,350

(22) PCT Filed: Apr. 30, 2010
(86) PCT No.: PCT/US10/33113

§ 371 Date: Oct. 26, 2011

(30) Foreign Application Priority Data
Apr. 30, 2009 (US) 61174493

(51) Int. Cl. B32B 3/12; B32B 37/14; B32B 38/00

(52) U.S. Cl. 428/116; 156/257; 156/60

(57) ABSTRACT

An array (100) of honeycomb substrates (10) comprises honeycomb substrates (10), a plurality of which have, for each substrate, substrate cells extending from a first end of the respective substrate to a second end and substrate sides extending from the first end to the second end. The substrates of the plurality are arranged in an array with sides of respective substrates facing one another and cells of respective substrates extending in a common direction. One or more channels (12) are defined by facing substrate sides of two or more substrates of the plurality (100) and the one or more channels (12) extend in a direction perpendicular to the common direction.

### PRIORITY

The present application claims priority to U.S. Provisional Patent Application No. 61174493, filed 30 Apr., 2009.

### BACKGROUND

The present disclosure relates to honeycomb structures used as reactors or heat exchangers, or “minireactors” formed into an array, and particularly to methods of joining the structures so as to form channels through the array in a direction perpendicular to the common direction of the honeycomb cells and to the resulting arrays.

### SUMMARY

In forming an array or honeycomb devices for use as a reactor or reactor array, channels may be machined into selected side faces of honeycomb substrates so that when the substrates are joined together one or more high aspect ratio channels are formed through the array in a direction perpendicular to the common direction of the honeycomb cells. Substrates may be joined together using a frit or a cement, or even a compression seal if desired, on selected side faces.

According to one embodiment, an array of honeycomb substrates comprises honeycomb substrates, a plurality of which have, for each substrate, substrate cells extending from a first end of the respective substrate to a second end and substrate sides extending from the first end to the second end. The substrates of the plurality are arranged in an array with sides of respective substrates facing one another and cells of respective substrates extending in a common direction. One or more channels are defined between facing substrate sides of two or more substrates of the plurality, and the one or more channels extend in a direction perpendicular to the common direction.

According to another embodiment, an array of honeycomb substrates comprises honeycomb substrates, a plurality of which have, for each substrate, substrate cells extending from a first end of the respective substrate to a second end and substrate sides extending from the first end to the second end. The substrates of the plurality are arranged in an array with sides of respective substrates facing one another and cells of respective substrates extending in a common direction. One or more channels are defined along the cells of two or more substrates of the plurality of substrates, and the channels extend from within a first substrate of the plurality through a substrate side thereof into a second substrate of the plurality through a substrate side thereof. The respective sides through which the one or more channels pass may be sealed to each other.

According to yet another embodiment of the invention, a method is provided of making an array of honeycomb substrates, the method including providing a plurality of honeycomb substrates having side faces and machining channels into selected ones of the side faces of the plurality of honeycomb substrates, in a direction generally perpendicular to a substrate cell direction, then sealing the channels by sealing the selected of the side faces to other side faces of the plurality of honeycomb substrates. The method may further include machining channels into one or more other side faces of the plurality of honeycomb substrates, in a direction perpendicular to the substrate cell direction, prior to the step of sealing.

Among other uses or applications of these embodiments of the present invention is the provision of a very flexible method for incorporating cross-flow heat exchange channels in a large array of substrates, with the cross-flow channels having low pressure drop and a large open frontal area, resulting in large honeycomb-based heat exchangers, or reactors with heat exchange.

### BRIEF DESCRIPTION OF THE FIGURES

FIG. 1 is a perspective view of a honeycomb substrate being prepared according to one or more embodiments of the present invention;

FIG. 2 is a perspective view of the substrate of FIG. 1 showing further steps according to one or more embodiments of the present invention;

FIGS. 3 and 4 are perspective views of the assembly of multiple honeycomb substrates according to one or more embodiments of the present invention;

FIG. 5 is a plan view of an assembled minireactor array or honeycomb substrate array according to one or more embodiments of the present invention;

FIG. 6 is a perspective view of a honeycomb substrate being prepared according to one or more further embodiments of the present invention;

FIG. 7 is a plan view of an assembled minireactor array or honeycomb substrate array according to one or more still further embodiments of the present invention;

FIG. 8 is a plan view of an assembled minireactor array or honeycomb substrate array according to one or more yet further embodiments of the present invention;

FIG. 9 is a plan view of an assembled minireactor array or honeycomb substrate array according to one or more still further embodiments of the present invention;

FIG. 10 is a perspective view of a honeycomb substrate being prepared according to one or more still further embodiments of the present invention;

FIG. 11 is a plan view of an assembled minireactor array or honeycomb substrate array according to one or more yet further embodiments of the present invention;

FIG. 12 is a perspective view of a honeycomb substrate being prepared according to one or more yet further embodiments of the present invention;

FIG. 13 is a plan view of an assembled minireactor array or honeycomb substrate array according to one or more still further embodiments of the present invention;

FIG. 14 is a perspective view of a honeycomb substrate being prepared according to one or more still further embodiments of the present invention;

FIG. 15 is a plan view of an assembled minireactor array or honeycomb substrate array according to one or more yet further embodiments of the present invention that may use substrates such as that of FIG. 14;

FIG. 16 is a perspective view of a honeycomb substrate being prepared according to one or more yet further embodiments of the present invention;

FIG. 17 is a perspective view of a honeycomb substrate being prepared according to one or more still further embodiments of the present invention;

FIG. 18 is a cross-sectional view of channels of the a substrate of the type shown in FIGS. 12 and/or 14;

FIG. 19 is a cross-sectional view of channels of the a substrate of the type shown in FIG. 16;

FIG. 20 is a cross section high aspect ratio channels which are an alternative to channels of the types shown in FIGS. 18 and/or 19 in the various multiple embodiments of the present disclosure.

### DETAILED DESCRIPTION

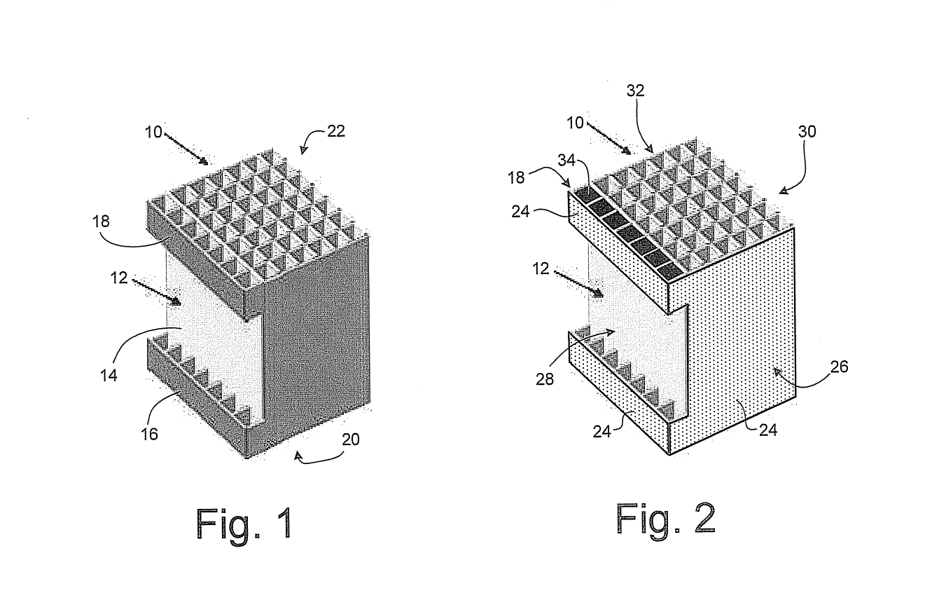

A machined channel 12 may be formed on one side face of a rectangular honeycomb substrate 10 as shown in FIG. 1. This channel 12 is preferably formed in a green substrate 10 prior to sintering by a simple milling, sawing or belt sanding operation, but it may also be formed on a fully-sintered or partially-sintered substrate 10 if desired. The depth of the machined channel 12 (measured normal to the side face of the substrate 10) may be one cell, as shown in the figure, or deeper. Cell walls of the substrate 10 are desirably removed in the area of the channel 12 so that a smooth sidewall surface 14 is formed along the machined channel 12. The width of the machined channel (measured parallel to the direction of cells of the substrate 10) should be less, desirably only slightly less, than the length of the substrate 10, so that two relatively narrow rows of cells 16, 18 remain near each respective end face 20, 22.

Next the substrate is sintered (assuming green-substrate channel machining operations). As shown in FIG. 2, according to one embodiment of the present invention, after substrate sintering, a frit sealing material 24 is applied to selected side faces of the substrate 26, 28. In additional embodiments, the sealing material may also be a cement 24 or some type of organic adhesive 24, depending on requirements of the intended use of the resulting array.

Frit may be applied via various processes, including doctor-blading, screen-printing, spray application, or by use of frit preforms. By orienting a number of substrates 10 in a row with either end faces or selected side faces touching one another (not shown), the frit may be applied in a continuous process. In general frit application is required on at most two adjacent substrate side faces 26, 28, simplifying the application process since each substrate 10 can rest on a non-frit coated side face 30, 32 (not directly visible in FIG. 2) or end face 20, 22 (as indicated in FIG. 1) during frit application.

End face cells 16, 18 directly over or beneath the machined channel are also be plugged, with frit 34, or with other suitable plug material 34 (shown in cells 18 only) for alternative embodiments. This prevents unintended mixing of fluid flowing in machined channels with fluid flowing in the substrate's open cells. A frit paste may be applied to plug the cells by first masking those cells which are to remain open, for example.

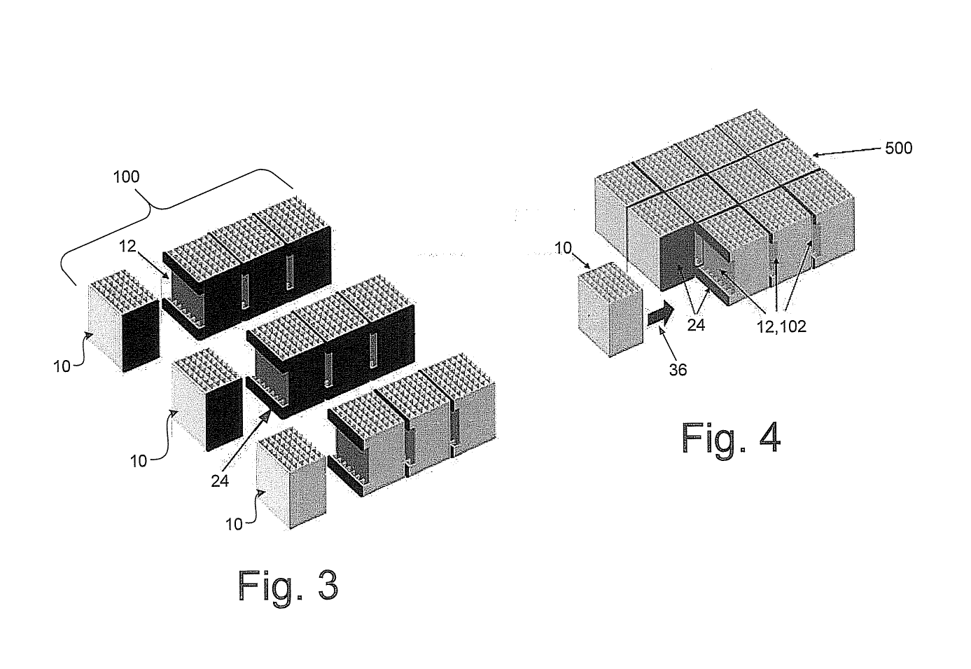

With reference to FIGS. 3 and 4, after frit or other sealant is applied, a set 100 of substrates 10 are joined together in an arrayed assembly or array 500, one embodiment of which is shown in FIGS. 3 and 4, showing the set 100 of machined and sealant-coated substrates 10 during assembly into an array 500. While a regular array 500 of identical shapes is shown, irregular arrays and substrates having various cross sections and shapes may be combined, as one alternative aspect of the various embodiments disclosed herein, if desired. Substrates 10 in the embodiment shown are oriented so that machined channels 12 align with one another to form high aspect ratio channels 102 through the assembled array 500, shown with one substrate 10 remaining to assemble in FIG. 4, in the direction indicated by the arrow 36. When the substrates 10 are packed together in the array 500 of FIG. 4, their fit-coated facing sides come into contact with each other. During subsequent frit sintering, the frit softens and flows to faun a seal with the facing side faces. If desired, the array 500 of substrates 10 may be sintered in a 45 degree V-block (not shown) so that as the frit shrinks on sintering, gravity assists in preventing any gaps from opening between the respective substrates 10.

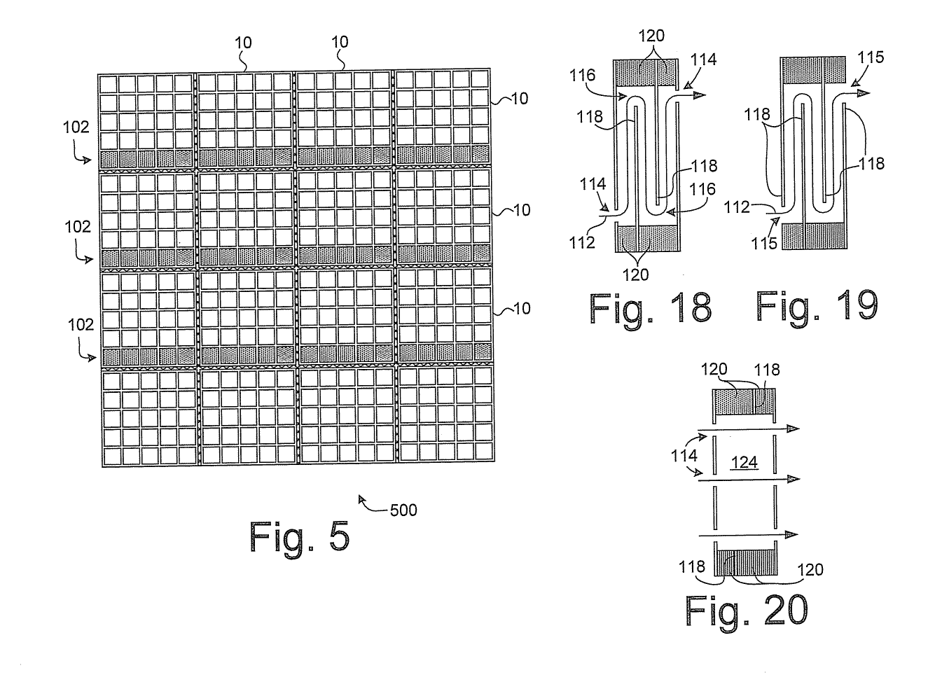

After frit sintering a substrate array is formed that provides short straight channels in close proximity to a series of high aspect ratio cross-flow channels. The structure of such an array can be used as an efficient large area cross-flow heat exchanger. Overall heat transfer performance depends on thermal conductivity of the substrate material, the substrate channel layout and geometry, and the machined high aspect ratio channel geometry as well as working fluid properties. FIG. 5 is a plan view of an assembled array 500 with machined channels 102 formed between substrates 10.

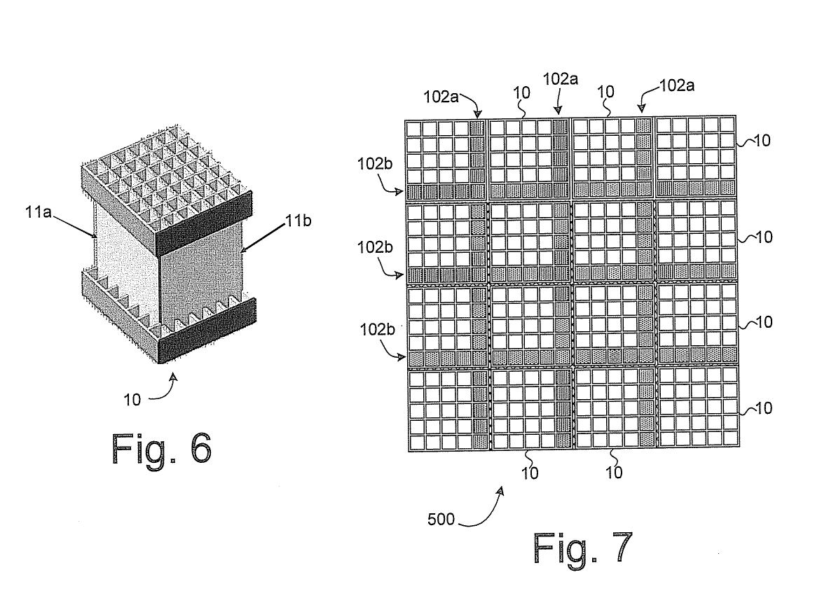

In another aspect or alternative embodiment, the substrate channel machining operation can be performed on multiple side faces, as shown in FIG. 6, where side faces 11a and 11b of substrate 10, adjacent side faces, are machined. Substrates 10 of this type may be joined together in an array 500 having crossed internal channels 102a and 102b as shown in the plan view of FIG. 7. These internal channels 102a, 102b may optionally be connected to external inlet and outlet feed manifolds, not shown, on the four side faces of the array 500.

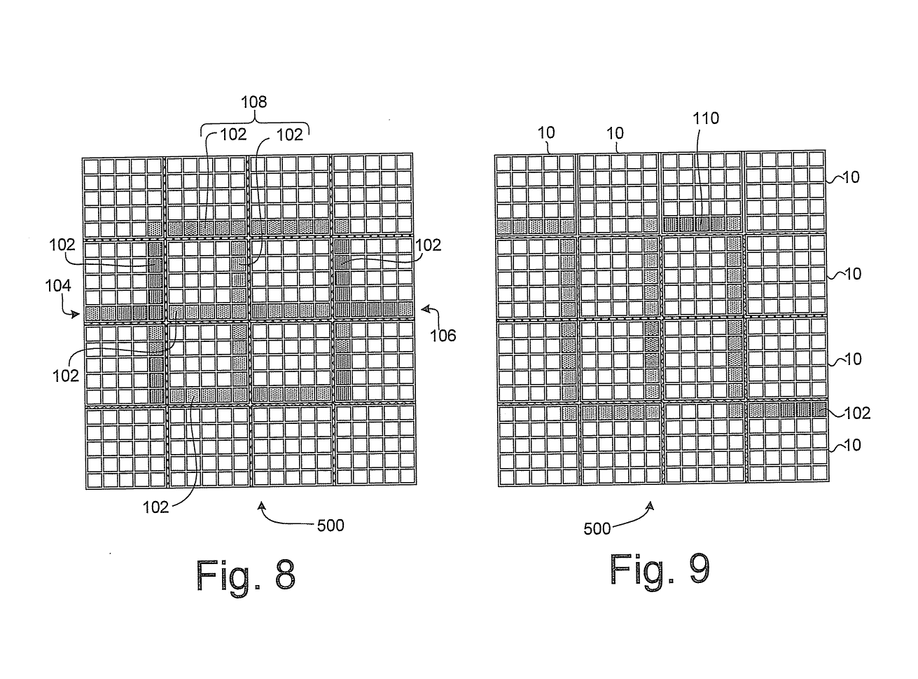

By selectively machining high aspect ratio channels into side faces of individual substrates, more complex channel routing configurations may be formed through the array. For example, FIG. 8 shows a plan view of an array configuration where single feed inlet and outlet channels 104, 106 at the array exterior are internally manifolded to an array 108 of high aspect ratio channels 102. In another configuration shown in plan view in FIG. 9, the high aspect ratio channel 102 running between substrates 10 is arranged to form a serpentine 110 in the plane perpendicular to the open cells of the substrates 10, which serpentine 110 passes near all substrates 10 in the array 500.

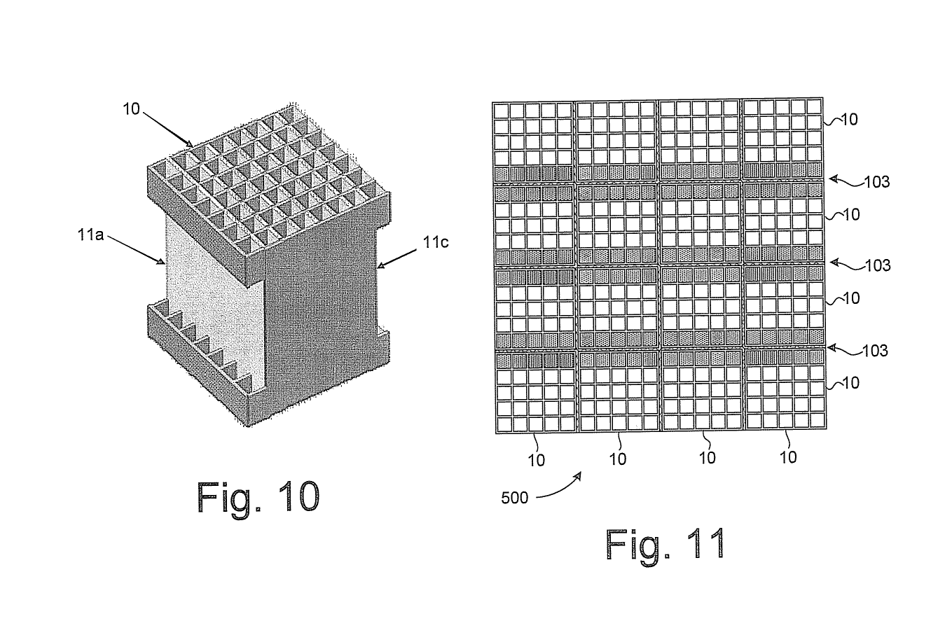

The substrate channel machining operation may also be performed on opposite substrate side faces 11a, 11c, as shown in FIG. 10. When these substrates 10 are joined together in a substrate array 500 as shown in the plan view of FIG. 11, double-wide high-aspect-ratio channels 103 are formed. This embodiment is useful to reduce pressure drop in the high aspect ratio machined channels 103, especially for configurations where substrate cell dimensions are very small. This may be the case when high heat transfer is required in the open cells via large sidewall surface areas and short mean heat transfer distances from cell center to cell sidewall. Triple or quadruple wide channels and larger may be used if desired, made by machining deeper channels in the substrate side faces. Use of deeper machining and/or double wide or wider channels between substrates my be applied to any high aspect ratio channel layout within a substrate array, including all those shown or otherwise disclosed herein.

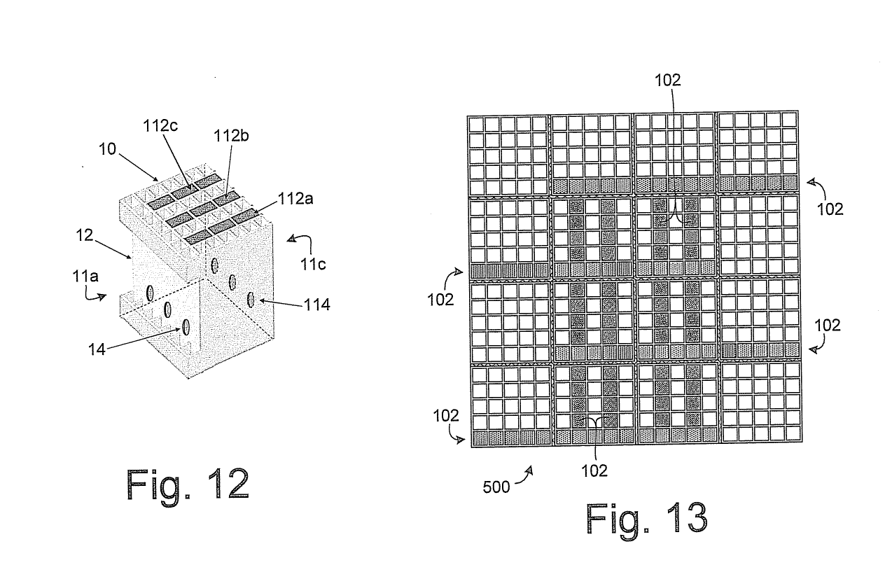

According to another embodiment of the present invention or according to another aspect which may optionally be applied to various of the embodiments disclosed herein, the substrates that make up the substrate array can have their end faces machined to form U-bend regions so as to form serpentine channels extending up and down along the direction of the cells of the substrate(s), traveling from cell to cell at or near the ends of the substrates and entering and exiting from the side of the substrate(s) or the side of the array, in the direction perpendicular to the open cells. An example of this is shown in FIG. 12, where three serpentine channels 112a, 112b, 112c are routed in parallel across a substrate 10. Channel sidewall holes 114 are drilled into substrate side faces 11a, 11c to enable fluid transport through the serpentine channels 112a, 112b, 112c. The holes 114 at side face 11a are within the channel 12 as shown. These substrates 10 may be assembled into a substrate array 500 as shown in FIG. 13, where high aspect ratio channels 102 running between substrates 10 distribute fluid to serpentine channels 112 that run through each substrate 10 or through selected ones of substrates 10. An exemplary cross section showing the U-bends and the resulting serpentine channel is shown in FIG. 18. As seen there, the U-bends 116 are formed by a combination of lowered (machined away) sidewalls 118 at the ends of the honeycomb substrate and plugs 120 that do not extend to the lowered sidewalls 118.

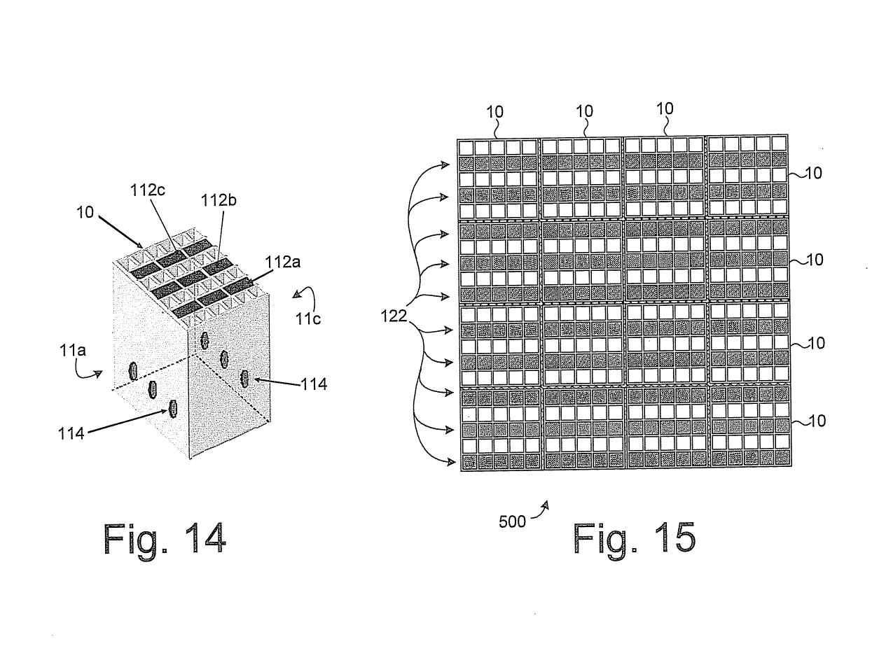

It is also possible to fabricate each substrate so only serpentine channels are provided. FIG. 14 shows such a substrate 10, with end face machining to create serpentine channel U-bends and channel sidewall holes 114 for serpentine inlet and outlet ports. Such substrates 10 can be coated with frit on two adjacent side faces and assembled into a substrate array 500 as shown in FIG. 15. Substrates may be assembled so that side port holes 114 line up with one another, forming long serpentine channels 122 extending from within one substrate 10 to within another substrate 10 within the substrate array 500, or even extending completely through the array 500 as in the embodiment shown in FIG. 15.

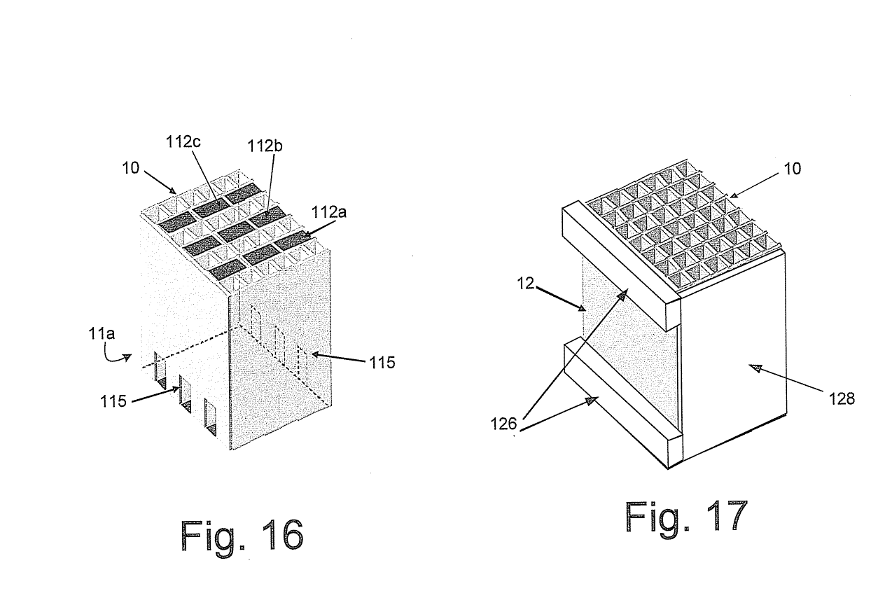

As an alternative to drilling side face channel holes, the same end face U-bend region machining process illustrated in FIG. 18 may be used to create U-bend notches 115 that extend to the side face of the substrate as shown in perspective view in FIG. 16 and in cross section in FIG. 19. Substrates 10 such as these may have selected side faces coated with frit, and then a number of substrates may be assembled into a substrate array that similar to the one shown in FIG. 15. Similarly to the array 500 in that figure, U-bend notches 115 may be aligned to one another during assembly to create long serpentine channels 122 extending from within one substrate 10 to within another substrate 10 within the substrate array, and even extending completely through the array 500 if desired.

Various combinations of side face machined high aspect ratio channels between substrates and end face machined serpentine U-bend channels may be combined together to form integrated manifold structures and channel layouts with optimized pressure drop and heat exchange performance. Other types of channels may also be formed in the substrate instead of U-bend serpentine channels, such as high aspect ratio channels formed by plunge machining operations, such as the high aspect ratio channel 124 depicted in cross-section in FIG. 20. Instead of removing merely the ends of side walls as in the embodiments of FIGS. 18 and 19, plunge machining or another suitable process is used to remove nearly the entire side wall 118, in an alternating pattern from alternate ends of the substrate. With plugs 120 closing the substrate above the channel 124 at both ends, a high-aspect-ratio channel 124 is formed. One or more holes 114 may be drilled as shown, or other suitable means may be used, to provide access.

As yet another embodiment of the present invention, high aspect ratio channels between substrates may be formed without machined channels or the need to machine substrates. Instead, the high aspect ratio channel regions may be formed by selective deposition of thick frit layers on one or more substrate sidewalls, or by use of shims, as represented in perspective view in FIG. 17. Thick frit layers 126, or shims 126 in an alternative approach, provide the spacing required to form the high aspect ratio channel 12 This approach does not require an additional step for plugging of end face channels directly over or beneath the high aspect ratio channel 12. A thin frit later 128 is applied on substrate side faces that do not require high aspect ratio channels. If a shim 126 is used, a thin frit may be used on both sides of the shim 126. After frit application, the substrates 10 are stacked in an array 500 similar to the one shown in FIGS. 3 and 4 and sintered. All design techniques presented above for arranging machined channels in arrays may be used with such frit-bordered high aspect ratio channels.

Within the various embodiments and variations thereof according to the present invention, proximity of high aspect ratio machined channels to short straight channels is easily adjusted by design to meet heat exchange requirements while maximizing open frontal area. Geometry of high aspect ratio channel and short straight channels can also be optimized to balance high heat transfer performance with low pressure drop. The various embodiments, particularly when frit seals are used, allow the short straight open cells of the substrates to operate at high pressures, with frit seals between substrates placed in compression or shear for maximum strength. The frit sealing area on substrate side faces can adjusted, increasing it as needed to increase mechanical strength at the fit-substrate interface.

Not as a limiting features, but as one potential benefits, the present invention can allow smaller substrates to be sintered individually in a short sintering cycle, relative to a long cycle required to sinter a single larger body. Even though a subsequent sintering cycle might be required if frit were used to join substrates together, this cycle would also be relatively short. Thus sintering time relative to device cross section may be reduced relative to large cross section honeycomb substrates. Flat side faces allow for simplified interfacing to other devices via bonded ports or O-ring seals. And substrate machining processes are relatively simple when only exterior channel forming operations are used. Such side face channel machining processes could be automated. Various high aspect ratio channels could also be laid out using a “mix and match” approach, where substrates with various side face machining patterns are joined together as needed to form the desired cross-flow heat exchange channel path.

Overall, the arrays of the present invention provide significant flexibility, since cross-flow heat exchange channels can be formed in relatively arbitrary sizes, both through side face channel machining as in some embodiments, and/or through internal substrate serpentine or high aspect ratio channels, as in other embodiments, and/or by the use of thick frit or shims and in the embodiment of FIG. 17. The methods of the present invention further provide reliable and efficient methods of producing these arrays.

The arrays disclosed herein are generally useful in performing any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

What is claimed is:

1. An array of honeycomb substrates comprising:
honeycomb substrates, a plurality of the substrates having, for each substrate, substrate cells extending from a first end of the respective substrate to a second end and substrate sides extending from the first end to the second end, the substrates of the plurality arranged in an array with sides of respective substrates facing one another and cells of respective substrates extending in a common direction; and
one or more channels defined between facing substrate sides of two or more substrates of the plurality, the one or more channels extending in a direction perpendicular to the array common direction.

2. The array according to claim 1 wherein the substrates of the plurality are sealed together at said facing substrate sides by a sintered frit.

3. The array according to claim 1 wherein the substrates of the plurality are sealed together at said facing substrate sides by a cement.

4. The array according to claim 1 wherein one or more substrates of the plurality includes serpentine passages defined along selected cells of the substrate, said serpentine passages being in fluid communication with the one or more channels defined between facing substrate sides.

5. The array according to claim 1 wherein the array is a regular array.

6. The array according to claim 1 wherein the sides of the substrates of the plurality are flat sides.

7. The array according to claim 1 wherein the substrates of the plurality have a rectangular cross-section in the plane perpendicular to their cells.

8. An array of honeycomb substrates comprising:
honeycomb substrates, a plurality of the substrates having, for each substrate, substrate cells extending from a first end of the respective substrate to a second end and substrate sides extending from the first end to the second end, the substrates of the plurality arranged in an array with sides of respective substrates facing one another and cells of respective substrates extending in a common direction; and
one or more channels defined along the cells of two or more substrates of the plurality of substrates, the channels extending from within a first substrate of the plurality through a substrate side thereof into a second substrate of the plurality through a substrate side thereof.

9. The array according to claim 8 wherein the channels defined along the cells of two or more substrates of the plurality of substrates are serpentine channels.

10. The array according to claim 9 wherein the channels defined along the cells of two or more substrates of the plurality of substrates are high aspect ratio channels

11. The array according to claim 10 wherein the high aspect ratio channels are straight channels.

12. A method of making an array of honeycomb substrates, the method comprising:
providing a plurality of honeycomb substrates having side faces;
machining channels into selected of the side faces of the plurality of honeycomb substrates, in a direction perpendicular to a substrate cell direction;
sealing the channels by sealing the selected of the side faces to other side faces of the plurality of honeycomb substrates.

13. The method according to claim 12, further comprising machining channels into the other side faces of the plurality of honeycomb substrates, in a direction perpendicular to the substrate cell direction, prior to the step of sealing.

14. A method of making an array of honeycomb substrates, the method comprising:
providing a plurality of honeycomb substrates having side faces and end faces;
positioned shims or frit layers on selected of the side faces of the plurality of honeycomb substrates at or near the end faces and not at other locations on the selected side faces and oriented in a direction perpendicular to a substrate cell direction;
positioning the honeycomb substrates into an array such that one or more channels are defined between two or more side faces including at least one of the selected side faces, the one or more channels extending in a direction perpendicular to the substrate cell direction and bounded by the respective shims or frit layers;
sealing the channels and sealing the array together by sealing the honeycomb substrates to each other at their respective adjacent side faces.
